(19) United States
(12) Patent Application Publication
(10) Pub. No.: US 2009/0021339 A1
(43) Pub. Date: Jan. 22, 2009

(54) HIGH-VOLTAGE FUSE

(75) Inventors: Heinz-Ulrich Haas, Olfen (DE); Dirk Wilhelm, Lunen (DE); Werner-Gunter Schmehl, Iserlohn (DE)

Correspondence Address: Jason H. Vick;Sheridan Ross, PC, Suite # 1200, 1560 Broadway, Denver, CO, 80202, US

(73) Assignee: SIBA FUSES GMBH & CO. KG, Luenen (DE)

(21) Appl. No.: 11/916,476

(22) PCT Filed: Jun. 7, 2006
(86) PCT No.: PCT/EP06/05398

§ 371 Date: Dec. 4, 2007

(30) Foreign Application Priority Data
Jun. 7, 2005 (DE) 10 2005 026 330.5
Jul. 13, 2005 (DE) 10 2005 033 212.9

(51) Int. Cl. H01H 85/165

(52) U.S. Cl. 337/248

(57) ABSTRACT

The invention relates to a high-voltage fuse comprising a tubular ceramic insulating member that is provided with at least one fusible element, an inner auxiliary cap which is placed on the insulating member and at least partly covers the outer surface of the insulating member in the front area of the insulating member, and an outer top cap that is placed on the auxiliary cap and at least partly covers the outer surface of the auxiliary cap. The insulating member is provided with at least one depression. The auxiliary cap is molded against the insulating member such that a positive connection to the insulating member is created in the depression. The auxiliary cap and the top cap are molded in the area of said depression in such a way that a positive connection is created. In order to create a high-voltage fuse which ensures that the insulating member is covered so as to be tight towards the outside even at elevated temperatures, a sealing means is provided in the depression while the top cap and/or the auxiliary cap are molded against the sealing means in said depression.

The invention relates to a high-voltage fuse, particularly to the use of high temperatures under oil according to the preamble of claim 1.

A high-voltage fuse of this type is already known from U.S. Pat. No. 5,892,427. This high-voltage fuse has an auxiliary cap on each of its ends and a top cap. Moreover, the known fuse has an insulating member with an annular groove running around the end side. To connect the caps to the insulating member, the auxiliary cap and the top cap are each crimped into the annular groove. It is disadvantageous that the known high-voltage fuse does not offer a sufficient seal. However, such a seal is necessary, especially when such fuses are installed under oil, so that there is oil-tightness. The known high-voltage fuse is not suitable for use at high temperatures under oil.

Oil-tight high-voltage fuses are generally installed under oil, with the maximum temperature sometimes exceeding 60° C. and reaching up to 150° C., generally at least 100° C. Safety tests, for example per IEC 60 282-1, are carried out at a maximum of 85° C., however. Nonetheless, it is of crucial importance that the aforementioned fuses be oil-tight at high temperatures of up to 150° C. The use of high-voltage fuses at high temperatures leads to the following problems. As the operation temperature increases, so does the material expansion of the caps. The press fit between the top cap and the auxiliary cap or between the auxiliary cap and the ceramic insulating member is particularly affected by this. The non-positive connection between the top cap and the auxiliary cap or between the auxiliary cap and the ceramic insulating member loses strength as the material expansion increases which, at elevated temperatures, can cause the caps to expand so that a gap forms and oil gets into the fuse. What is more, the pressure in the sealed insulating member increases as a result of the elevated temperatures. A lifting-off of the caps can occur here.

It is the object of the present invention to make available a high-voltage fuse of the type mentioned at the outset which is simple and economical to manufacture and also ensures sufficient oil-tightness at high temperatures.

The abovementioned object is achieved in a high-voltage fuse of the above-described type by virtue of the features of claim 1. Through the positive connection between the auxiliary cap and the insulating member, it is ensured that, even at elevated temperatures, a lifting-off of the auxiliary cap and hence of the top cap placed on the auxiliary cap from the insulating member does not occur and a penetration of oil into the inside of the insulating member does not occur. The positive connection, even at temperatures of greater than 100° C., preferably up to 150° C., ensures a sufficient strength of the caps on the ceramic tube, with even higher temperatures being possible in principle. Moreover, the high-voltage fuse according to the invention can be manufactured very simply and cost-effectively, with a sufficient oil-tightness being ensured even at elevated temperatures. The cost-effective manufacture is a result of the fact that only a single depression is necessary at each end of the insulating member which does not serve to produce a positive connection between the top cap and the auxiliary cap, but rather also accommodates the sealing component. Moreover, the auxiliary cap and/or the top cap acts on the sealing component in order to produce a strong sealing effect. A combinatorial effect of the positive connection between top cap or auxiliary cap and the insulating member on the one hand and the pressurizing of the sealing component by the upper cap or the auxiliary cap on the other hand is thus produced, specifically in the same depression of the insulating member. Finally, the rolling-in of the respective caps into the depression can be combined at the same time with the pressurizing of the seal in very simple and cost-effective embodiments.

To ensure an even greater strength of the caps on the insulating member, a provision can be made that the top cap is molded in such a manner against the auxiliary cap and/or the insulating member that a positive connection is formed between the top cap and the auxiliary cap and/or between the top cap and the insulating member. The invention is therefore based on the fundamental idea that the top cap and the auxiliary cap are positively connected to each other and/or to the insulating member in order to enable a sufficient oil-tightness of the high-voltage fuse according to the invention even at elevated temperatures.

In a preferred embodiment of the invention, the depression is designed as a circumferential annular groove in the insulating member, which can be produced simply and cost-effectively. Here, as has already been explained, the top cap and the auxiliary cap are molded in the area of the same depression or pressed in the direction of the depression, with the outer surface of the top cap preferably extending in the area of the depression over the outer surface of the auxiliary cap in the longitudinal direction of the insulating member, and with the molded area of the top cap also being provided at least in an area of the depression that is not covered by the auxiliary cap. This type of positive connection makes it possible to first place the auxiliary cap onto the insulating member and mold it to form a positive connection, with areas of the auxiliary cap being able to be pressed into the depression, for example. Subsequently, the top cap can be placed onto the auxiliary cap, far enough that the outer surface of the top cap extends beyond the covering cap of the auxiliary cap. The top cap is then formed in the area extending beyond the outer surface of the auxiliary cap and preferably pressed at least in areas into the same depression so that a positive connection between the top cap and the insulating member is formed.

In principle, it is of course also possible for the top cap and the auxiliary cap to have molded areas which are arranged over each other. For example, it is possible to roll the auxiliary cap and the top cap in overlapping areas together into a groove of the insulating member in order to form a positive connection between the caps and the insulating member. By contrast, in an alternative embodiment, a provision can also be made that molded areas of the top cap and the auxiliary cap are provided in at least two different depressions of the insulating member. For example, in order to form a connection between the caps and the insulating member which ensures sufficient strength at high temperatures, it is possible for the molded area of the auxiliary cap to be provided in the area of an annular groove located closer to the front side of the insulating member and running around the insulating member and the molded area of the top cap to be provided in the area of an annular groove located further away from the front side of the insulating member.

The tightness of the inventive arrangement of auxiliary cap, top cap and insulating member is ensured by a sealing component which is provided between the top cap and the insulating member and/or between the auxiliary cap and the insulating member. In principle, it is also possible to use a plurality of sealing components. Preferably, the sealing component is a sealing collar and/or a sealing ring. A provision can be made here that the sealing component is affixed in the depression of the insulating member. In the operational state, the sealing component is then located underneath the molded areas of the top cap and/or the auxiliary cap between the caps and the insulating member or also optionally at least over areas between the caps.

The position of the sealing component on the insulating member is determined by the arrangement of the sealing component in the depression. Here, during the molding process of the top cap and/or the auxiliary cap, the top cap and/or the auxiliary cap is molded against the sealing component, which means that the molded area of the top cap and/or the auxiliary cap presses the sealing component together. As a result, an especially strong sealing effect of the sealing component is produced. In addition, a provision can be made that the top cap and/or the auxiliary cap has molded areas which are longitudinally adjacent and separated by an unmolded area. As a result, the top cap and/or the auxiliary cap is molded in separate areas, with the sealing component rising up between the molded areas and ensuring the tightness of the connection. Here, the adjacent molded areas of the top cap and/or the auxiliary cap should be spaced apart by a certain interval, which makes the rising-up of the sealing component between the molded areas possible. The sealing component has sufficient elasticity, however, to seal off a gap forming in the event of an expansion of the caps at elevated temperatures and to ensure a secure positive connection.

In another preferred embodiment of the invention, a provision is made that the top cap and the auxiliary cap are molded such that, preferably by means of a sealing component, a positive connection between the top cap and the auxiliary cap and/or the insulating member and/or between the auxiliary cap and the insulating member is formed. In this respect, the invention is based on the fundamental idea of forming a positive connection through pressing of the auxiliary cap and/or the top cap onto the insulating member, with it being possible to provide at least one sealing component between the auxiliary cap and/or the top cap and the insulating member.

To form a positive connection, the auxiliary cap can be crimped over in the front area of the outer surface and/or the top cap can be pressed into the depression in the front area of the outer surface, preferably rolled into the annular groove. If only a single form closure molding process is provided, then it is possible to roll the auxiliary cap on the cap edge and the top cap in the center simultaneously from the outside. In this case, overlapping molded areas can be obtained by molding the auxiliary cap and the top cap together. It is also possible to roll the auxiliary cap and the top cap simultaneously from the outside, likewise on the cap edge, in a molding process so that, after the molding process, the auxiliary cap and the top cap each have a molded area which are not, however, arranged on top of each other.

In order to cover the depression provided in the insulating member, a provision can be made that the outer surface of the top cap extends beyond the area of the depression. In order to be able to place the top cap in a simple manner onto the auxiliary cap, another provision can be made that the outer surface of the top cap is flared outward on the front side.

Specifically, there are a great number of possibilities for arranging and modifying the high-voltage fuse according to the invention, in which respect reference is made on the one hand to the dependent patent claims on the other hand to the following detailed description of preferred sample embodiments of the invention referring to the drawing. In the drawing,

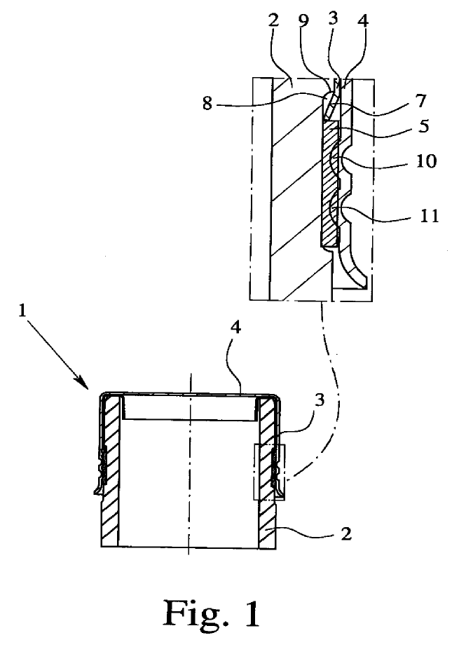

FIG. 1 shows a cross-sectional view of a first embodiment of a high-voltage fuse according to the invention,

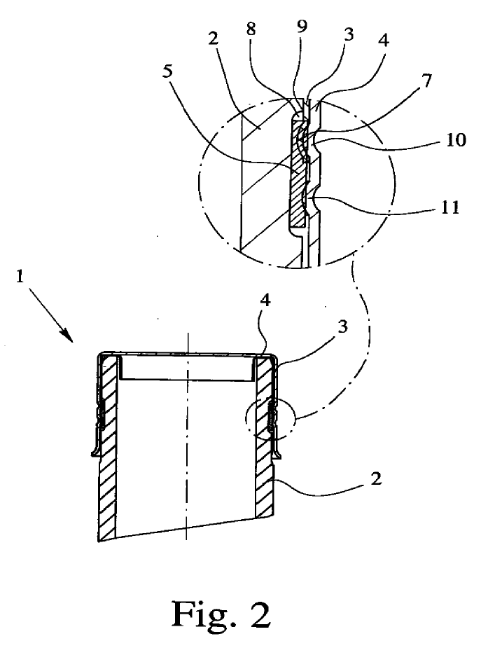

FIG. 2 shows a cross-sectional view of a second embodiment of a high-voltage fuse according to the invention, and

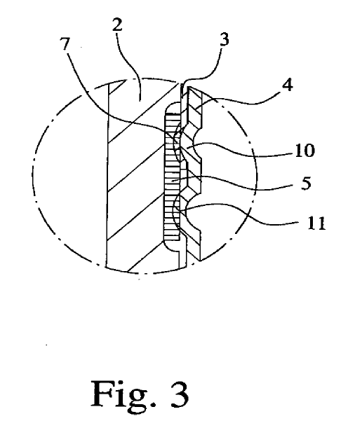

FIGS. 3 to 7 show detailed cross-sectional views of possible positive connections between top cap, auxiliary cap and insulating member in alternative embodiments of high-voltage fuses according to the invention.

Depicted in FIG. 1 is a first embodiment of an oil-tight high-voltage fuse 1 according to the invention which is provided for operation at temperatures of preferably up to 150° C. An auxiliary cap 3 is placed onto the high-voltage fuse 1 on the front side, and a top cap 4 is placed into the auxiliary cap 3. Here, the outer surface of the insulating member 2 is covered by the auxiliary cap 3 at least in part in the front area of the insulating member 2. According to the embodiment of the high-voltage fuse 1 according to the invention depicted in FIG. 1, the outer surface of the auxiliary cap 3 is covered completely by the outer surface of the top cap 4. Moreover, a sealing component 5 is located between the top cap 4 and the insulating member 2, with this being a sealing collar in the embodiments of the high-voltage fuse 1 according to the invention depicted in FIGS. 1 to 5.

It is not shown in detail that the auxiliary cap 3 can be in electrical contact via connecting links with connection caps of a fusible element provided on the inside of the insulating member 2. In the installed state, the top cap 4, in turn, is connected electrically to the auxiliary cap 3, with the electrical contact occurring toward the outside, preferably directly via the outer surface of the top cap 4.

In order to ensure an oil-tight covering of the ceramic insulating member 2 filled with sand in the operational state by the top cap 4 at high temperatures of generally above 100° C. to 150° C., a provision is made according to the invention that the auxiliary cap 3 is molded against the insulating member 2 such that a positive connection with the insulating member 2 is formed. In the sample embodiment depicted in FIG. 1, the outer surface of the auxiliary cap 3 is bent over in areas at the outer edge in the direction of the center longitudinal axis of the insulating member 2, with the molded area 7 of the auxiliary cap 3 formed during bending engaging in the inner area of a circumferential groove 8 of the insulating member 2. Here, the molded area 7 abuts a shoulder 9 of the insulating member 2, hence forming a positive connection between the auxiliary cap 3 and the insulating member 2.

The sealing component 5, in turn, is affixed in the groove 8 and abuts against the front side of the auxiliary cap 3 in the molded area 7. To connect the top cap 4, which is preferably placed non-positively on the auxiliary cap 3, in a positive manner with the auxiliary cap 3, a further provision is made that two further molded areas 10, 11 are provided by rolling of the top cap 4 into the groove 8, thus forming a positive connection with the auxiliary cap 3 by virtue of the sealing component 5. In this way, a non-positive connection is also produced between the sealing component 5 and the top cap 4. It is crucial in the embodiment shown in FIG. 1 that the molded area 7 of the auxiliary cap 3 and the other molded areas 10, 11 of the top cap 4 engage in the same groove 8 of the insulating member 2. This brings about a pressing-together of the sealing component 5, which increases the tightness of the connection. Although the top cap 4 and the auxiliary cap 3 are molded in the area of the same groove 8 in FIG. 1, it is of course also possible that molded areas 7, 10, 11 of the top cap and the auxiliary cap 3 also be produced in mutually separated depressions of the insulating member, preferably through rolling-in.

Depicted in FIG. 2 is another embodiment of a high-voltage fuse according to the invention, wherein the top cap 4 and the auxiliary cap 3 have overlapping molded areas 7, 10. For this, a provision is made that rolling-in can be performed simultaneously from the outside of the auxiliary cap 3 at the cap edge and of the top cap 4 in the center. The molded areas 7, 10 can thus be obtained through mutual molding of the auxiliary cap 3 and the top cap 4. Furthermore, it is possible to produce the other molded area 11 of the top cap 4 through rolling-in of the top cap 4 simultaneously or even subsequent to the mutual molding process of the auxiliary cap 3 and the top cap 4.

The detailed view shown in FIG. 3 shows a connection in an alternative embodiment of a high-voltage fuse 1 according to the invention, wherein molding of the top cap 4 is less pronounced than in the other molded area 11. A positive connection with the molded area 7 of the auxiliary cap 3 occurs in the other molded area 10. As a result, the sealing component 5 underneath the molded areas 7, 10 on the one hand and underneath the molded area 11 on the other hand is subjected to substantially the same pressing force, which results in a uniform load on the sealing component.

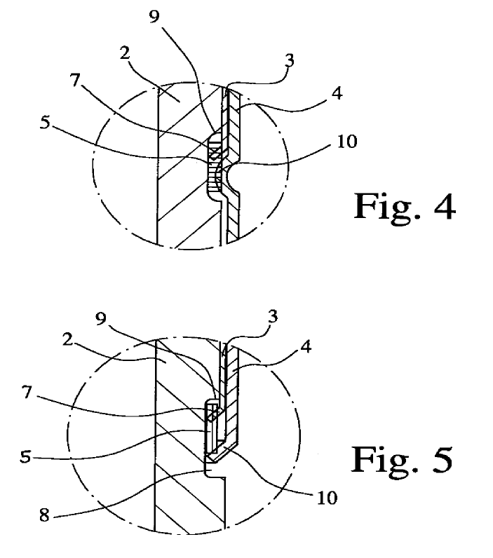

FIGS. 4 and 5 relate to other possibilities for forming a connection between the top cap 4, the auxiliary cap 3 and the insulating member 2. According to FIG. 4, the top cap 4 has only one other molded area 10 which is arranged transversely next to the molded area 7 of the auxiliary cap 3 relative to the adjacent front side of the insulating member 2. The molded area 7 of the auxiliary cap 3 is molded against the sealing component 5 and leads to a compressing of the sealing component 5 in this area. In the possibility depicted in FIG. 5 of forming a non-positive connection between the top cap 4, the auxiliary cap 3 and the sealing component 5 or a positive connection with the insulating member 2, a provision is made that the top cap 4 and the auxiliary cap 3 are each bent over at the outer circumferential edge in the direction toward the insulating member 2. The molded area 7 of the auxiliary cap 3 and the other molded area 10 of the top cap 4 engage in the groove 8 of the insulating member 2, with the insulating member 2 having different wall thicknesses on each side of the groove 8. The tightness between the auxiliary cap 3 or the top cap 4 and the insulating member 2 is ensured, in turn, by a sealing component 5.

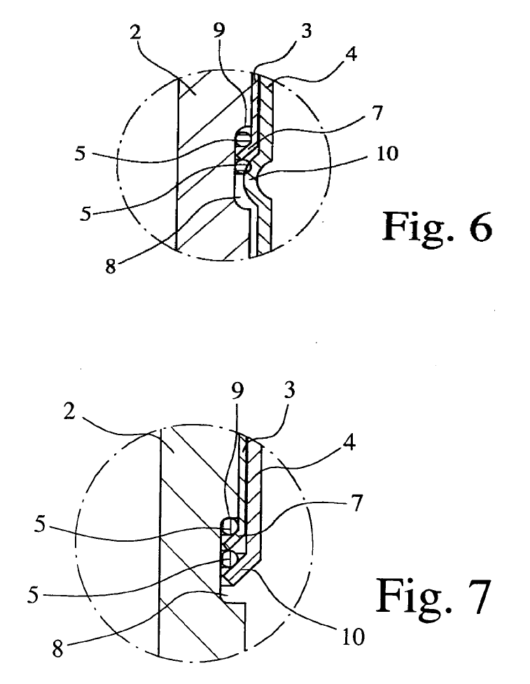

Shown in FIGS. 6 to 7 are detailed views of inventive connections between the top cap 4, the auxiliary cap 3 and the insulating member 2, as may be provided in alternative embodiments of the high-voltage fuse 1 according to the invention. According to FIGS. 6 and 7, two sealing components 5, for example O-rings, are respectively provided. In the embodiment depicted in FIG. 6, sealing component 5 adjacent to the shoulder 9 of the groove 8 is arranged between the insulating member 2 and the auxiliary cap 3. The second sealing component 5 is provided underneath the molded area 7 of the auxiliary cap 3 between the insulating member 2 and the other molded area 10 of the top cap 4, with the second sealing component 5 being compressed by the molded area 10 of the top cap 4. The tightness is thus ensured even at elevated temperatures.

Finally, according to FIG. 5 and FIG. 7, the insulating member 2 has a wall thickness on the side of the groove 8 facing away from the adjacent front side of the insulating member 2 which corresponds substantially to the total wall thickness resulting from the wall thickness of the insulating member 2 in the front area of the insulating member 2 and the wall thickness of the auxiliary cap 3. In this way, it is possible to push the top cap 4 far enough up onto the insulating member that the groove 8 is completely covered.

As follows from the foregoing description of preferred embodiments of the high-voltage fuse 1 according to the invention, the invention takes a completely new path, preferably with the auxiliary cap 3 and the top cap 4 being pressed or rolled in relative to a depression of the insulating member 2 to form a non-positive and positive connection, and with the molded area 7 of the auxiliary cap 3 working together with at least one other molded area 10, 11 of the top cap 4 and at least one sealing component 5. Preferably, a provision is made here that the auxiliary cap 3 and the top cap 4 are rolled into the same depression, preferably a circumferential annular groove 8 of the insulating member 2. As a result, a positive connection with the insulating member is made available which makes it possible to use the high-voltage fuse 1 according to the invention even at elevated temperatures without risk of a lifting-off of the auxiliary cap 3 and/or of the top cap 4 and hence a loss of oil-tightness at elevated temperatures. Moreover, it is impossible for oil to penetrate into the fuse 1 in the event of an expansion of the caps 3, 4 at elevated temperatures, since a sufficient seal of the insulating member 2 is ensured by the sealing component 5 at all times. For this purpose, it is necessary that the sealing component have sufficient elasticity.

Moreover, the invention permits a combination as needed of the features of inventive high-voltage fuses 1 described on the basis of FIGS. 1 to 7, even if this is not described in detail.

1. High-voltage fuse, with a tubular ceramic insulating member having at least one fusible element, with an inner auxiliary cap which is placed on the insulating member and at least partially covers the outer surface of the insulating member in the front area of the insulating member, and with an outer top cap which is placed on the auxiliary cap and at least partially covers the outer surface of the auxiliary cap, wherein the insulating member has at least one depression, wherein the auxiliary cap is molded against the insulating member such that a positive connection is formed with the insulating member in the depression, and wherein the auxiliary cap and the top cap are molded in the area of the same depression such that a positive connection is formed, wherein a sealing component is provided in the same depression and that the top cap and/or the auxiliary cap is molded against the sealing component in the same depression.

2. High-voltage fuse as set forth in claim 1, the top cap is molded against the auxiliary cap and/or the insulating member such that a positive connection is formed between the top cap and the auxiliary cap and/or the insulating member.

3. High-voltage fuse as set forth in claim 1, characterized in wherein the depression is embodied as a circumferential annular groove.

4. High-voltage fuse as set forth in claim 1, wherein the outer surface of the top cap extends beyond the outer surface of the auxiliary cap in the area of the depression, with the molded area of the top cap also being provided at least in one area of the depression not covered by the auxiliary cap.

5. High-voltage fuse as set forth in claim 1, wherein the top cap and the auxiliary cap have at least one common molded area.

6. High-voltage fuse as set forth in claim 1, wherein the molded area of the top cap and the molded area of the auxiliary cap are provided in at least two different depressions, with the molded area of the auxiliary cap being provided in a depression which is located nearer the front side of the insulating member and the molded area of the top cap being provided in a depression which is located further away from the front side of the insulating member.

7. High-voltage fuse as set forth in claim 1, wherein at least one sealing component is provided between the top cap and the insulating member and/or between the auxiliary cap and the insulating member.

8. High-voltage fuse as set forth in claim 1, wherein the sealing component is embodied as a sealing collar and/or as a sealing ring.

9. High-voltage fuse as set forth in claim 1, wherein the top cap has at least two molded areas which are adjacent in the longitudinal direction and are separated by a non-molded area.

10. High-voltage fuse as set forth in claim 1, wherein the auxiliary cap is crimped over in the front area of the outer surface and/or the top cap is pressed into the depression in the front area of the outer surface.

11. High-voltage fuse as set forth in claim 1, wherein overlapping molded areas can be obtained through the mutual molding of the auxiliary cap and the top cap.

12. High-voltage fuse as set forth in claim 1, wherein the outer surface of the top cap extends over the area of the depression in the longitudinal direction of the insulating member and/or that the outer surface of the top cap is flared outward on the front side.
